(19) United States
(12) Patent Application Publication
(10) Pub. No.: US 2011/0140868 A1
(43) Pub. Date: Jun. 16, 2011

(54) METHOD AND A SYSTEM FOR EXCHANGING INFORMATION

(75) Inventor: Dan Hovang, Sjöbo (SE)

(73) Assignee: SECURITAS DIRECT AB, Malmo (SE)

(21) Appl. No.: 12/637,282

(22) Filed: Dec. 14, 2009

(51) Int. Cl. G05B 19/02

(52) U.S. Cl. 340/12.55; 340/6.1

(57) ABSTRACT

A method of exchanging information through a wireless communication link, comprising the steps of sending activation instructions to at least one alarm detector and receiving and displaying data relating to status of at least said alarm detector in a wireless remote control device. The method includes the steps of detecting motion of said remote control device, enabling the displaying of data after detecting the motion of the remote control device, and enabling sending of instructions for disarming a selected group of alarm detectors after detecting the motion of the remote control device.

A system for exchanging information between a remote control device, at least one alarm detector and a gateway. The remote control device comprises a wireless communication unit, displays and inputs. Also included are motion detectors and an arming input for receiving arming instructions, wherein the arming input is operatively coupled to the wireless communication unit and wherein said gateway is set to a “Armed Home” state upon receipt of an arming instructions forwarded by the wireless communication unit.

The embodiments of the invention relate to a method and a system for exchanging alarm information through a wireless link, and, more particularly, from a remote control device.

### PRIOR ART

Prior art remote control devices exist in different forms. One type of a remote control device includes a wireless communication unit and a simple switch used for sending an arming signal and a disarming signal, respectively, to the base station. Other devices include an RFID (Radio Frequency IDentification) which has the advantage that no battery or other power source needs to be included in the device.

Battery powered devices suffer from a general disadvantage related to battery drain. Different measures have been suggested to lower the power consumption of such devices. Among such measures can be mentioned more efficient radio communication means and other low power electronic circuits. More sophisticated remote control devices are less frequently used since low power failures are considered more risky in alarm systems.

### SUMMARY

An object of the embodiments of the present invention is to avoid the drawbacks set out above and to provide an improved method of exchanging information in an alarm system with the use of a remote control device. The remote control device is connected over a wireless link to a gateway, also referred to as a control panel or base station. Further advantageous features and improvements are described below.

Various embodiments of a remote control device in accordance with the invention are operable in two different modes. In a first sleeping mode only a minor part of electronic components and other means are active. In the sleeping mode the power consumption is very low resulting in an extended life time of the batteries. In a second and active mode, display means and communication means included in the remote control device are activated and all relevant functions are available.

In accordance with embodiments of the invention the mode of operation is changed when motion of the remote control device is detected and optionally when the gateway transmits selected alarm signals. After detecting such motion the remote control device will enter the active mode. When the display means is activated, different types of information previously received and stored in the remote control device are displayed to the user. This information may include that a detector included in the alarm system has detected fire, that a door or a window has been opened or any other desired condition.

In the active mode it is further possible to arm and disarm the alarm system as set out below and to carry out voice information exchange with a central monitoring station. In the sleeping mode there still is a sporadic radio communication with the gateway so as to allow registration and indication of alarm conditions. The remote control device also may send an acknowledge signal to the gateway so as to confirm that it is operable.

In various embodiments the remote control device is arranged to arm and disarm the alarm system only at selected levels, such as perimeter protection. By arming the alarm system, an internal state of the gateway is changed to an alarmed state. In the alarmed state, reporting of an alarm signal from alarm detectors results in forwarding of alarm information to the central monitoring station. The alarm state also may result in the generation of an alarm sound and/or other local indication of the alarm. The present alarm state of the gateway can be transferred to selected or all alarm detectors The remote control device preferably is designed to have a size and weight that will not encourage a user to bring it out of the premises.

In case of an emergency situation or if other circumstances are fulfilled it is possible to establish a voice connection between the remote control device and the central monitoring station. In various embodiments the connection is established through the gateway. If the emergency situation arises at the location of the remote control device, the user initiates the connection by using input means of the remote control device. In a simple embodiment, the input means in this respect is an alarm button. Emergency situations and also other reasons allow the central monitoring station to initiate voice communication.

An alarm signal also is transmitted to the central monitoring station to ensure that appropriate measures are taken. When the voice connection is established, the user is able to inform personnel at the central monitoring station about the present situation and an output device will output voice information that is received from the central monitoring station. In a simple embodiment the output device comprises a loudspeaker.

The remote control device is provided also with other forms of output means. In various embodiments a graphic display unit is included and also symbol elements. The symbol elements can be provided with backlighting means that are activated and lit when there is a transition from the sleeping mode to the active mode. In various embodiments the symbol elements may include symbols depicting fire, an open door and a locked door. The graphic display unit can also be provided with backlighting means.

Besides an alarm button and/or other alarm activating means the input means in various embodiments include an arm and disarm button, or separate buttons for arming and disarming the alarm system, and a talk symbol indicating that voice communication is available.

The detection of motion of the remote control device can be provided by any type of accelerometer, including those based on piezoelectric effect, changes in capacitance, piezoresistive effect and inertially responsive spring-mass systems. The term accelerometer is used herein for any device that will produce a signal responsive of tilting and/or moving the remote control device. In various embodiments the accelerometer is sensitive also to shock or freefall and capable of discriminating between a normal lift up of the device and a situation where the device is dropped or when a person carrying it is falling.

### BRIEF DESCRIPTION OF THE DRAWINGS

In order that the manner in which the above recited and other advantages and objects of the invention are obtained will be readily understood, a more particular description of the invention briefly described above will be rendered by reference to specific embodiments thereof which are illustrated in the appended drawings.

Understanding that these drawings depict only typical embodiments of the invention and are not therefore to be considered to be limiting of its scope, the invention will be described and explained with additional specificity and detail through the use of the accompanying drawings in which:

FIG. 1 is a schematic perspective view of an installation including one embodiment of a system in accordance with the invention.

FIG. 2 is a schematic block diagram of an installation including an embodiment of the invention as shown in FIG. 1 and an associated central monitoring station.

FIG. 3 is a schematic block diagram of one embodiment of a remote control device in accordance with the invention.

### DETAILED DESCRIPTION

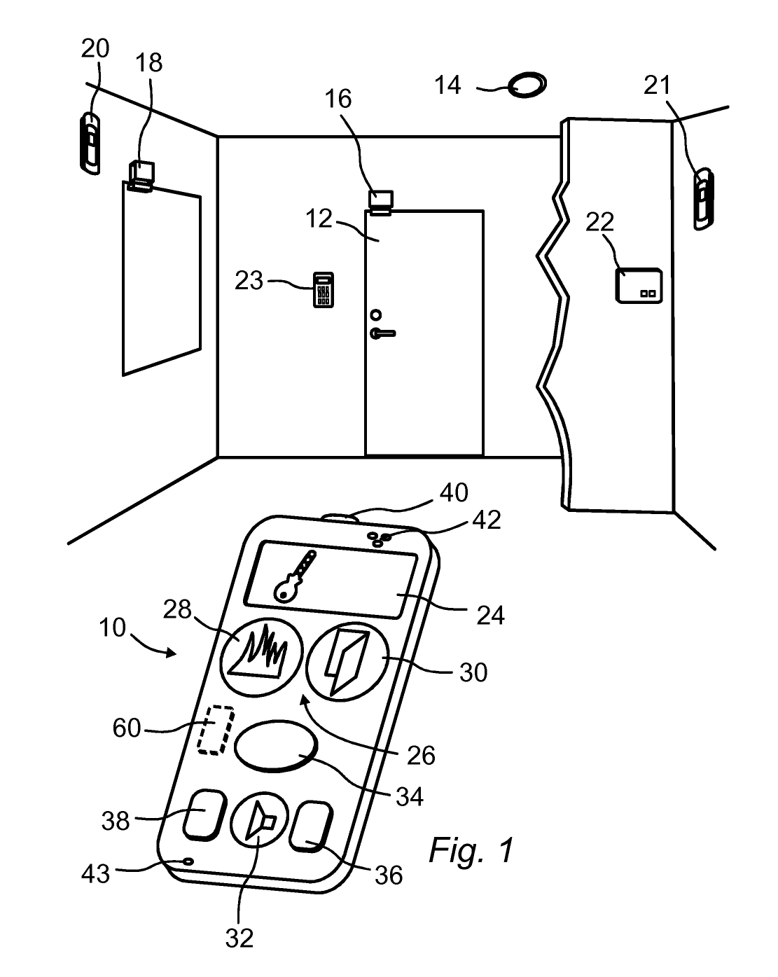

The installation shown in FIG. 1 is arranged in a conventional manner in a room. A remote control device 10 is shown schematically as carried by a user. The installation includes a plurality of wireless alarm detectors, including a smoke detector 14, a first perimeter alarm detector 16, a second perimeter alarm detector 18 and a first infrared detector 20 or similar photodetector. Alarm signals from smoke detector 14 and detectors for gas or water leakage normally result in an alarm state, irrespective of the alarm system being armed or not.

The first infrared detector 20 is an interior detector. Alarm signals from the detectors are transmitted to a wireless control panel or gateway 22. Detectors and the gateway form an alarm system. When the alarm system is armed the gateway will transmit an alarm signal to a central monitoring station (not shown) and normally also generate a sound alarm when an alarm signal from a detector is received. The smoke detector 14 is always armed. Arming of the system normally is requested using a keypad 23 arranged by the door 12. Normally inputting of a code such as a PIN code is required to arm and to disarm the alarm system.

The smoke detector 14 is mounted in the ceiling of the premises and the infrared detector 18 is mounted on a wall. The first perimeter alarm detector 16 is installed above a door 12 to detect when the door is opened. A corresponding second perimeter alarm detector 18 is installed by a window 13. In the shown embodiment the keypad 23 is arranged by the door 12. The gateway 22 is mounted in a room separated from the entrance of the premises. In the shown embodiment a second infrared detector 21 is arranged to cover the gateway 22, so as to ensure that an intruder cannot tamper with the gateway 22 when the system is armed. The second infrared detector 21 is an interior detector.

The alarm system can be armed in different ways and into different alarm system states, such as “Disarmed”, “Armed Home” and “Armed Away”. If the system is set to “Disarmed” it will not alarm to perimeter or interior detectors. If the alarm system is set to “Armed Home” the alarm system will generate an alarm at the occurrence of a breach of perimeter detectors and selected interior detectors, but not to a breach of the interior detectors in general. If the system is set to “Armed Away” it will alarm to a breach of the perimeter or interior detectors.

The state of the system is determined by the needs of the occupants of the premises. If all of the occupants are leaving the premises then the alarm system should be set to “Armed Away”. If the occupants will be staying within the premises for an extended period of time then the alarm system should be set to “Armed Home”. For all other scenarios the alarm system should be set to “Disarmed”. In the “Armed Home” state a selected group of detectors is armed. In various embodiments the selected group of detectors includes the perimeter detectors and interior detectors covering sections of the premises that are not used by the occupants. Each installation can be set up with different detectors included in the selected group.

Preferably alarm system is armed into the “Armed Away” state by the keypad 23 only, or by an additional mobile arming and disarming device (not shown). Different arming states can be selected by pressing an associated button in connection with entering the code. The remote control device 10 is used for arming the system into the “Armed Home” state only and is intended to be used by the bed or otherwise in a more stationary way than other mobile devices. If the alarm system has been armed to the state “Armed Away,” the remote control device 10 cannot be used to disarm the system. Normally, smoke detectors and other similar alarm detectors are active and will produce alarms when triggered irrespective of the present state of the alarm system.

The remote control device 10 has a size and thickness that makes it less suitable to be carried in a pocket. It is provided with a display 24 and further display symbols 26. Preferably the display symbols are indicators of higher priority, such as a fire symbol 28 and an open symbol 30 indicating that a door or window or other perimeter entrance has been or is opened. The display 24 can be used for indicating more detailed information or information of lower priority. In various embodiments the display is used to indicate whether the alarm system is in an armed or disarmed state. A further display symbol is a talk symbol 32 indicating that a voice connection to a central monitoring station is open. This function is further explained below. The display symbols may all or at least some of them be provided with backlight means, so as to be distinctively observable also without ambient light.

The remote control device 10 is provided with a set of input means including a panic or assault button 34. By pressing the panic button 34 an alarm signal forwarded to the central monitoring station irrespective of the present state of the remote control device. The remote control device is further provided with an arming button 36 and a disarming button 38. In various embodiments the arming button 36 is combined with the disarming button 38 in a single button and the function is toggled between arming and disarming. When the remote control device 10 is used for arming only one or a plurality of perimeter alarm detectors or another group of selected alarm detectors are armed, the alarm system will be armed to the “Armed Home” state. A group of selected alarm detectors may include one alarm detector only. By limiting the function of the remote control device as described it is ensured that the alarm system is not fully but partly armed when a user still is present in the premises. Furthermore, it also ensured that an intruder will not be able to disarm the alarm from an “Armed Away” state even if the intruder gains access to the remote control device.

A lamp 40 can be used in emergency situations and when the remote control device 10 is operated in the night-time. A switch (not shown) can be used to manually switch on the light. In various embodiments the lamp is switched on automatically in case of fire and other high priority alarm situations. A separate power source, such as a battery, is coupled to the lamp when power consumption is especially considered. Alarm signals and other sounds are generated in a loudspeaker 42. The loudspeaker 42 is used also during voice communication as described below. The remote control device is provided with a microphone 43 for capturing voice signals when a user talks. Display 24, display symbols 26, fire symbol 28, open symbol 30 and the loudspeaker are all indicating means used to inform a user of present conditions and status.

The remote control device 10 normally is placed in a horizontal position on a table such as a bedside table. When left in a stationary position for a predetermined and adjustable time period, the remote control device enters a sleeping mode. All power consuming circuits and display units are switched off or put into a low power state to reduce the power consumption. Also, when in the sleeping mode, a wireless connection still is maintained with the gateway 22. The wireless connection during sleeping mode mainly is a short beacon signal to establish a confirmation that the remote control device 10 is operable.

In various embodiments a wireless connection is established during a short time period followed by a longer time period without any signalling. The short time period can have a duration of 4 ms while the longer time period can last for 2 seconds. During a previous phase, such as during installation, an accurate synchronization between the remote control device and the gateway is carried out. A similar synchronization can be carried out also between the gateway and the alarm detectors.

Should an alarm signal be sent from an alarm sensor to the gateway and the alarm system is in armed state a wake up signal is sent from the gateway to the remote control device. After receiving the wake up signal, the remote control device will enter the active mode and display information regarding the present alarm situation. The displaying of information can include switching on the backlight means corresponding to the appropriate alarm symbol. High priority alarms, such as fire alarms, normally also result in activation of a sound alarm. In various embodiments also the lamp 40 will be switched on to facilitate movements in the premises.

The remote control device 10 also will change from sleeping mode to active mode when motion of the remote control device is detected. A motion corresponding to a lower level of acceleration, such as when the remote control device is lifted or tilted, will force the remote control device into the active mode and switch on backlight and display unit. A motion detector 60 is provided in the remote control device.

Status of alarm detectors and other information previously received from the gateway will be displayed during a predetermined time period. The lamp 40 can be switched on manually if desired. When a predetermined and adjustable time period has expired without any alarms or movements of the remote control device the status is reset to sleeping mode to save power.

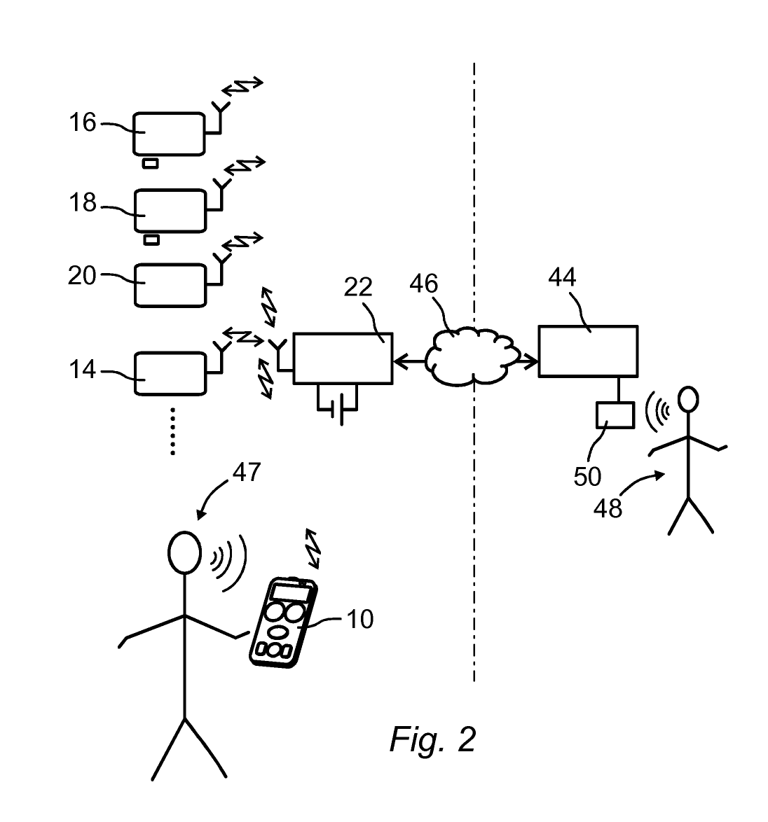

In the embodiment shown in FIG. 2 the alarm system comprising a remote control device 10, a first perimeter alarm detector 16, a second perimeter alarm detector 18, an infrared detector 20 and a smoke detector 14 is operatively coupled to a central monitoring station 44 through the gateway 22 and a network connection 46. In various embodiments a plurality of interconnected smoke detectors are provided. Interconnected smoke detectors will forward alarm signals to each other and thus improve the alarm signalling throughout the premises. The network connection 46 can be the internet, a wired telephone connection, a cellular telephone connection or any other suitable connection or combination of connections. The gateway 22 is provided with a self-contained power supply such as a battery so as to ensure communication and operation generally also during power failures.

The remote control device 10 will change mode from sleeping mode to active mode when the panic button is pressed on the remote control device. When the panic button is pressed by a user 47 a panic alarm signal will be transmitted to the gateway 22 and then further on to the central monitoring station 44. The central monitoring station initiates a voice communication between a supervisor 48 or other personnel and the user 47. A voice channel between the central monitoring station and the remote control device can be established also during other conditions and in either direction.

In various embodiments the voice communication is a half-duplex communication system and communication will be possible in both directions, but only in one direction at a time. While the supervisor 48 is talking the communication system will transfer voice signals from the central monitoring station 44 to the remote control device 10. Sound signals will be emitted through the loudspeaker 42. In the shown embodiment the transfer of voice signals will go through the gateway 22. In other embodiments there will be a direct connection between the remote control device and the central monitoring station for the voice communication. An audio unit 50 at the central monitoring station 44 is used by the supervisor.

The user is invited to talk and to transfer voice information in the reverse direction when the talk symbol of the remote control device is switched on. Normally, the supervisor or the central monitoring station will control the direction of communication switch on the talk symbol. Voice signals from the user are captured by the microphone 43.

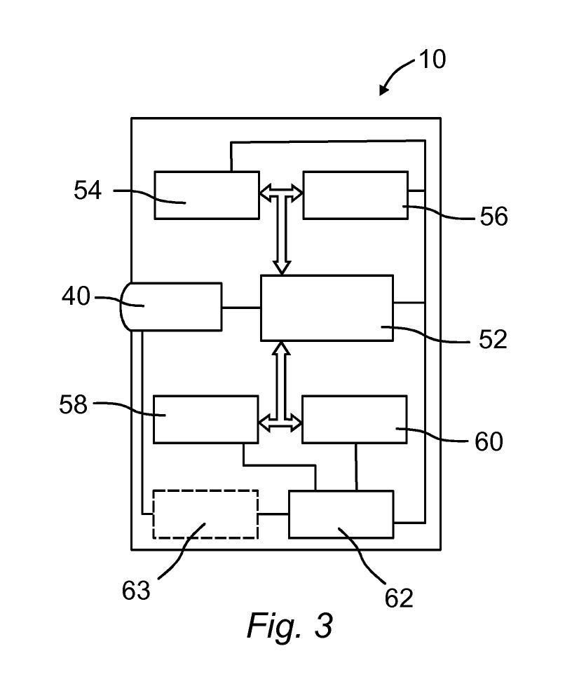

A basic configuration of the remote control device 10 is shown in FIG. 3. A central processing unit 52 is coupled to an input unit 54 and an output unit 56. The input unit 54 is coupled to the arming button 36, the disarming button 38 and the panic button. In the shown embodiment the input unit 54 also is coupled to and receives voice signals from the microphone 43. In various embodiments the central processing unit 52 is arranged also to code and to decode voice signals during voice communication.

An output unit 56 is coupled to the central processing unit 52 and also to the display 24 and to the display symbols 26. The output unit 56 also is coupled to the talk symbol 32 and the loudspeaker 43. During voice communication the output unit 56 receives decoded voice signals from the central processing unit 52 or a separate voice handling unit (not shown).

All communication to and from the gateway 22 is handled in a wireless communications unit 58 coupled to the central processing unit 52. In various embodiments the communications unit 58 comprises circuits and electronic devices that are suitable for radio communication at available frequencies, including circuits for coding/decoding, encryption/decryption, power adjustments. The communications unit 58 together with the central processing unit 52 are arranged to handle an authentication process between the wireless units, so as to ensure that wireless units not belonging to the alarm system interfere in or endanger the function of the alarm system.

A motion detector 60 is coupled to the central processing unit 52 to give an alert signal when predetermined levels of motion of the remote control device are detected. In various embodiments the motion detector comprises an accelerometer that can be based on different physical properties. The accelerometer can include a solid state detector utilizing a piezoelectric effect, changes in capacitance, piezoresistive effect and inertially responsive spring-mass systems for example.

A first level of motions where the acceleration corresponds to lifting or tilting the remote control device 10 sets the remote control device into the active mode to energize backlight and other display functions. Arming of a selected group of alarm detectors is now possible. A second level of motions corresponds to dropping the remote control device or the acceleration that will be detected when a person carrying the remote control device falls. In various embodiments detection of the second level of motions results in transmitting a panic message to the central monitoring station and opening of the voice communication.

The central processing unit 52 comprises a clock circuit (not shown) that is used for timing purposes, such as determining time intervals between radio communications with the gateway when the remote control device is in the sleeping mode. A general power supply unit 62 is coupled to all unit power consuming units of the remote control device 10. In various embodiments the general power supply unit 62 comprises a battery. As long as the remote control device is in the sleeping mode the total power consumption of the remote control device is very low and also standard batteries will last for at least one year and preferably at least three years at normal use.

An optional power supply 63 can be provided for the lamp 40. In accordance with such an embodiment the useful life of the general power supply will be more predictable. The optional power supply 63 can be a battery that is readily available through a cover of a housing of the remote control device.

While certain illustrative embodiments of the invention have been described in particularity, it will be understood that various other modifications will be readily apparent to those skilled in the art without departing from the scope and spirit of the invention. Accordingly, it is not intended that the scope of the claims appended hereto be limited to the description set forth herein but rather that the claims be construed as encompassing all equivalents of the embodiments of the present invention which are apparent to those skilled in the art to which the invention pertains.

What is claimed is:

1. A method of exchanging information through a wireless communication link, comprising the steps of:
sending activation instructions to at least one alarm detector;
receiving and displaying data relating to status of at least said alarm detector in a wireless remote control device;
detecting motion of said remote control device;
enabling the displaying of data after detecting the motion of the remote control device; and
enabling sending of instructions for disarming a selected group of alarm detectors after detecting the motion of the remote control device.

2. A method of claim 1, wherein the steps of enabling sending of instructions for disarming a selected group of alarm detectors, wherein the selected group comprises perimeter alarm detectors and selected interior alarm detectors, and disabling sending of instructions for disarming alarm detectors not included in said selected group of alarm detectors.

3. A method of claim 1, further comprising the steps of determining acceleration of the remote control device and generating an alarm signal when a determined value of acceleration exceeds a predetermined value.

4. A method of claim 2, further comprising the steps of determining acceleration of the remote control device and generating an alarm signal when a determined value of acceleration exceeds a predetermined value.

5. A method of claim 1, further comprising the step of activating backlight of display symbols arranged on the remote control device when motion of said remote control device is detected.

6. A method of claim 2, further comprising the step of activating backlight of display symbols arranged on the remote control device when motion of said remote control device is detected.

7. A method of claim 1, further comprising the steps of receiving a control signal allowing reception of voice signals and transmitting radio signals carrying information corresponding to said voice signals.

8. A method of claim 1, further comprising the steps of receiving alarm signals generated in alarm detectors and activating associated indicating means arranged on the remote control device when an alarm signal is received.

9. A system for exchanging information between a remote control device, at least one alarm detector and a gateway, said remote control device comprising wireless communication unit, displays system comprising: inputs, the motion detector operatively coupled to the displays for displaying information received from the at least one detector when motion is detected,
an arming input for receiving arming instructions, wherein the arming input is operatively coupled to the wireless communication unit and wherein a gateway is set to a partly armed state upon receipt of an arming instructions forwarded by the wireless communication unit, the gateway in the partly armed state being arranged to generate an alarm signal upon receiving alarm signals from a selected group of detectors, and
a disarming input for receiving disarming instructions, wherein the disarming input is operatively coupled to said wireless communication unit and wherein the gateway is set to a disarmed state from a partly armed state only upon receipt of an disarming instructions forwarded by said wireless communication unit.

10. A system of claim 9, wherein the remote control device is provided with a plurality of display symbols and associated backlight means.

11. A system of claim 9, wherein the motion detector is arranged to detect a first level of acceleration corresponding to lifting or tilting the remote control device, and a second level of acceleration corresponding to dropping the remote control device.

12. A system of claim 9, wherein the remote control device is provided with a loudspeaker and a microphone operatively coupled to a communication unit for providing voice communication between the remote control device and the gateway.

13. A system of claim 12, wherein the communication unit comprises a half-duplex communication means arranged to allow a one way voice communication between the remote control device and the gateway.

14. A system of claim 12, wherein the remote control device is provided with a talk symbol that is activated when voice communication in the direction from the remote control device to the gateway is allowed.

15. A system of claim 13, wherein the remote control device is provided with a talk symbol that is activated when voice communication in the direction from the remote control device to the gateway is allowed.

16. A system of claim 9, wherein the selected group of alarm detectors consists of perimeter alarm detectors.

17. A system of claim 9, wherein the remote control device is provided with a lamp and wherein the motion detector is operatively coupled to the lamp, so as to activate the lamp when motion is detected.

18. A system of claim 17, wherein the remote control device is provided with a separate power supply supplying power to the lamp.
